(19) United States
(12) Patent Application Publication
(10) Pub. No.: US 2012/0297416 A1
(43) Pub. Date: Nov. 22, 2012

(54) SYSTEM AND METHOD OF PROVIDING TRANSACTIONS OVER A TELECOMMUNICATIONS SYSTEM

(75) Inventors: Sandro Torrieri, Edmonton (CA); Jason Salmon, London (CA)

(73) Assignee: MAIN EVENT LOTTERY CORPORATION, Edmonton (CA)

(21) Appl. No.: 13/475,718

(22) Filed: May 18, 2012

Related U.S. Application Data
(60) Provisional application No. 61/488,640, filed on May 20, 2011.
(60) Provisional application No. 61/543,153, filed on Oct. 4, 2011.

(51) Int. Cl. G06Q 30/02; A63F 13/00; H04N 21/458

(52) U.S. Cl. 725/32; 705/14.49; 705/14.66; 705/14.4; 705/14.1; 463/41

(57) ABSTRACT

Lotteries and other games of chance are provided to a user via a telecommunications system, such as internet, television or a cellular or wireless network. A similar user experience is provided via multiple networks and consumer devices. The user is provided with targeted advertising based on information about the user including what they would do with winnings The targeted advertising may be supplied in response to the user winning An income level of the user may also be estimated for use in targeting advertising.

### CROSS-REFERENCE TO RELATED APPLICATIONS

This application claims the benefit under 35 USC 119(e) of U.S. provisional No. 61/488,640 filed May 20, 2011 and No. 61/543,153 filed Oct. 4, 2011.

### TECHNICAL FIELD

Transactions and gaming over a telecommunication system

### BACKGROUND

With consumer patterns and preferences shifting with technology, lottery corporations need new avenues for connecting with customers. In order to maximize the profitability of providing lotteries over a telecommunication system, there is also a need for methods of targeting advertising in a system for providing lotteries over a telecommunications system.

Consumers watch an average of 5 hours of television each day. This quantity of viewing, in addition to the number of programming packages and channels available to the customer results in numerous commercial advertisements being aired during, before, and after scheduled programming. As a result, customers often watch commercials which are relevant, and of interest, competing for their viewing pleasure in addition to promoting applications, products, services, for entertainment and informational purposes. In order for broadcasters, application developers, and content providers to maximize the exposure to their specific content there exists a need to better organize, sort, and access content to ensure interested users are connected with specific content in a timely fashion.

### SUMMARY

There is provided a method and apparatus for targeted advertising in an electronic lottery system, comprising the electronic lottery system collecting input from a user about what the user would do with winnings if they won a lottery, generating a database based on the user input, and sending the user an advertisement, offer or coupon based upon the information in the database. The database may include information inferred from user input. The method may also further comprise monitoring whether the player wins a lottery using the electronic lottery system and sending the player the advertisement, offer or coupon in response to the user winning The method may also further comprise estimating an income level of the user and sending the player the advertisement, offer or coupon based on the income level. The method may also further comprise comparing the estimated income level of the user to a threshold and in the event that the estimated income level is below the threshold suggesting to the user that the user top off a purchase with a credit card or additional form of payment. There is also provided a method of providing an offer to a person, comprising informing the person of a real offer and a fake offer and requiring the person to choose one of the real offer and the fake offer and providing the person with the real offer if they choose the real offer and not providing the person with either the real offer or the fake offer if they choose the fake offer. There is also provided a method of providing an offer to a person, comprising providing the user with a chance to receive one or more of a selection of offers, the user receiving the one or more of the selection of offers based on a randomizing procedure. There is also provided a method of allowing a user easy recording of advertised programs. There is also provided a method of selling over a communications network, comprising delivering an offer to a customer, notifying the customer of an option to accept the offer or make a lower offer in reply, setting a threshold of acceptance, and, if the lower offer exceeds the threshold, accepting the lower offer.

There is provided a method and apparatus for television viewers (customers or subscribers), within a Digital TV environment, to watch a television advertising commercial, and during the airing of that said commercial schedule a future event to occur at specific time. The event may include causing a consumer electronic device to schedule a Reminder which will pop up at a predetermined time reminding the viewer to tune to a specific channel to watch a program which was determined to be of interest, further it may cause the consumer electronic device to Auto Tune to the channel at the specific time without further user intervention, or it may cause the Digital or Personal Video Recorder (DVR or PVR) to record that program. The method may further comprise launching an Interactive TV application which would result in the viewer purchasing ecommerce goods and services, or accessing specific informational services specific to the commercial advertising message.

There is also provided a method of delivering content to a user over a communications device, comprising receiving at the communications device a code embedded in an advertising stream, the code corresponding to a service and in response to user input while the advertising stream is being received, the communications device providing the user with access to the service.

There is also provided a method of delivering content to a user over a communications device, comprising receiving at a personal video recorder a code embedded in an advertising stream, the program code corresponding to a service and in response to user input while the advertising stream is being received, the personal video recorder providing the user with access to the service.

A method of brokering a transaction over a communications network, the method comprising: receiving from a potential customer a discount request for a merchant; determining an interest level in the discount request among other potential customers; if the interest level is above a threshold, taking at least a step towards completing a transaction corresponding to the discount request with at least one of the potential customers. A related system is also provided. The interest level may be the number of potential customers interested in the discount request.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a flow diagram showing a process of creating an account for a lottery application;

FIG. 2 is a flow diagram showing a process of using a lottery application;

FIG. 3 is a flow diagram showing a process of paying winnings to a user;

FIG. 4 is a flow diagram showing a process of sending the user a promotion based on information from the user on what the user would do with winnings;

FIG. 5 is a flow diagram showing a process of sending the user a promotion based on information as in FIG. 4 but also using an estimated income level of the user;

FIG. 6 is a diagram showing an embodiment of a system for providing lotteries over a cable television network; and

FIG. 7 is a flow diagram showing a process of sending a user a promotion based on information from the user on what they would do with winnings.

FIG. 8 is a flow diagram showing a process of brokering a transaction over a telecommunications network.

FIG. 9 is a diagram showing an embodiment of a system for brokering a transaction over a telecommunications network.

### DETAILED DESCRIPTION

Immaterial modifications may be made to the embodiments described here without departing from what is covered by the claims.

A system and method for providing lotteries over a telecommunications system is provided. A software program (lottery application) is loaded onto a consumer electronic device. The consumer electronic device may be, for example, a Set Top Box (for example Cable, IPTV, or Satellite), a gaming console (for example XBOX, PlayStation, or WII), Over The Top TV, a cell phone, a smart phone, or a computer. The software program may be, for example, downloaded or loaded from a computer readable memory. Downloading may include streaming from a cloud. The consumer electronic device is connected to a telecommunications network (for example, cable, satellite, cell phone network, or the internet). The software program connects to a server via the telecommunications network. If a device has a web browser, a separate lottery application may not be required as the necessary features may be provided by a web site loaded by the web browser. The server may be configured to be connected to via multiple telecommunications networks or multiple servers may share a common database. The server and the software programs for different consumer electronic devices may be configured to provide a similar user experience, including similar interactions and similar presentation.

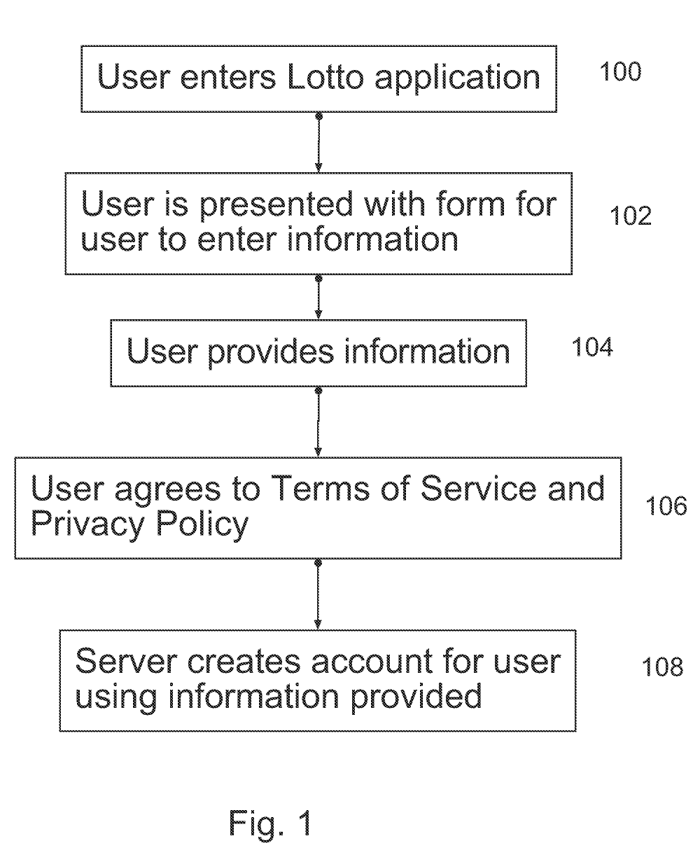

When a user first uses the lottery application, they may be prompted to create an account or log into an existing account. The same account may be used for more than one consumer electronic device and telecommunications network. A process for creating an account is shown in FIG. 1. The user enters the application (or loads a website) in step 100. The user is presented with a form to enter information in step 102. The form may be delivered by the server via the telecommunications network or may be stored within the lottery application. The user enters information into the form in step 104. The information in the form is sent to the server via the telecommunications network. The information in the form may include, for example, name, address, date of birth, phone number, email address, language preference (for example English or French), login name & password, security questions, and payment method (Visa, MasterCard, PayPal, Debit transfer, etc.). The information may be split between multiple forms. The user may enter information in the form using, for example, a physical or virtual keyboard. The user may also set up preferences such as jackpot alerts (winning tickets, large pots, etc.), weekly safe gaming limit amounts and opt out preferences. Alternatively, default preferences may be used until the user specifically changes them. The user is prompted to agree to a Terms of Service and Privacy Policy and does so in step 106. The server uses the information provided to create an account for the user in step 108. The server may be configured to allow the user to log in to the account using the same username and password from different consumer electronic devices and over different telecommunications networks.

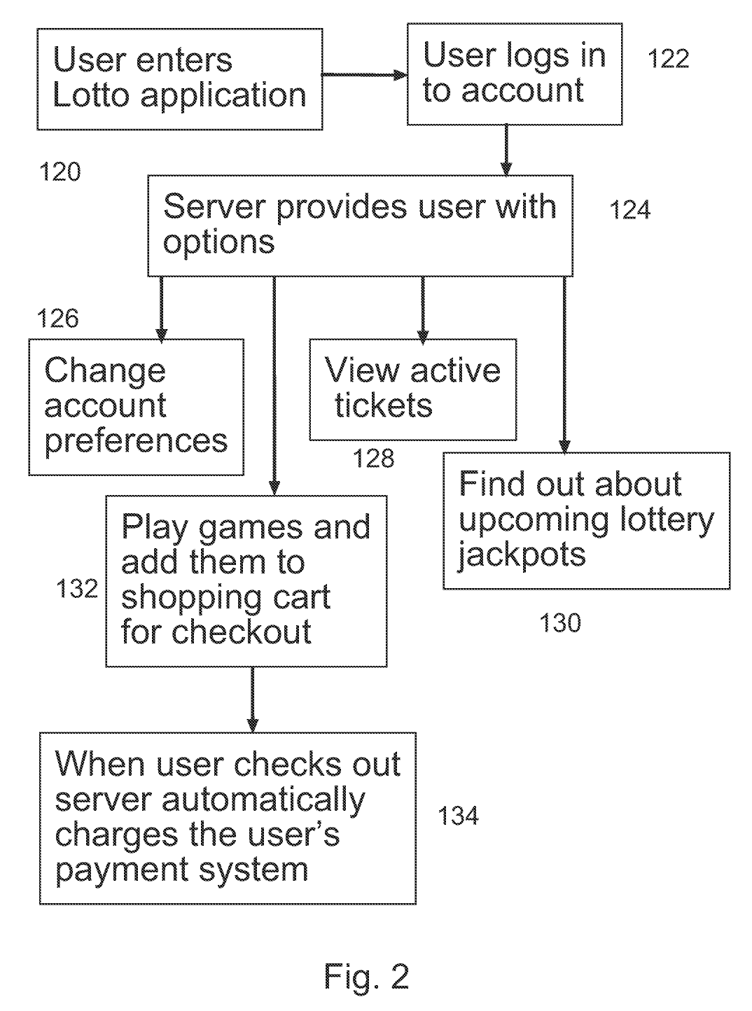

The user may use the lottery application as shown in FIG. 2. In step 120 the user activates the lottery application. The user is prompted to log into their account and does so in step 122. In the event that the user does not yet have an account, the user may create one as shown in FIG. 1. In step 124 as shown in FIG. 2, the user is provided with options. The options provided, and when possible the presentation of options, may be consistent between different consumer electronic devices and telecommunications networks. The options may include for example, changing account preferences (step 126), viewing active tickets (step 128), finding out about upcoming lottery jackpots (step 130), or playing games (lotteries) and adding them to a shopping cart for checkout (step 132). In the event that the user elects to play a game and checks out, the server may automatically charge the user's payment system (e.g. credit card, debit, PayPal) using the payment information provided by the user, or withdraw funds from a float, or account, which the user has funded at another time. The ticket will reside in their account but an email or text message may also be generated sending them a receipt and copy of their Lotto ticket as confirmation.

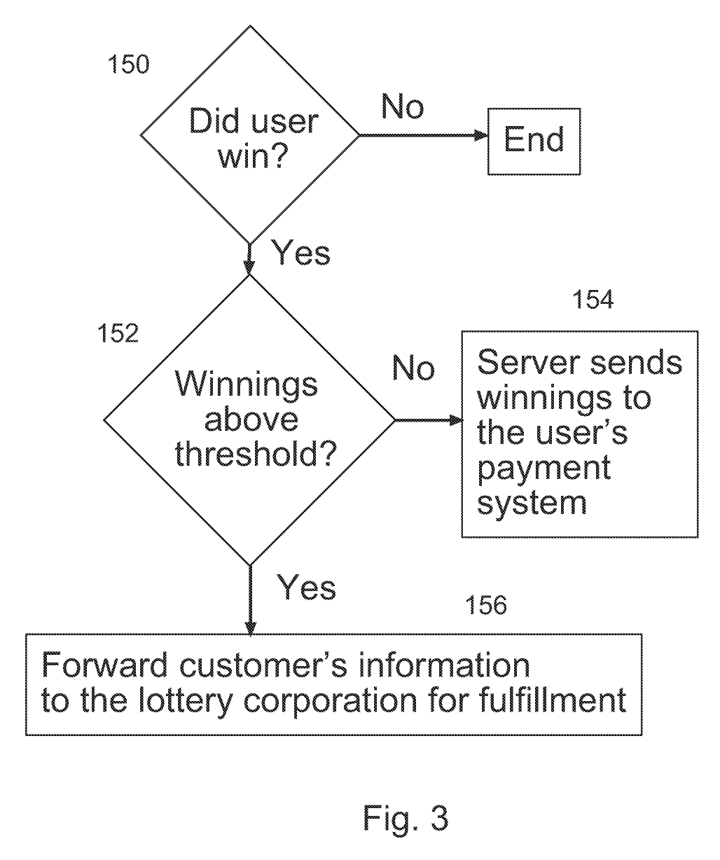

The server may be operated by a corporation and provide access to lotteries provided by a lottery corporation independent from the corporation operating the server. Payment of lottery winnings to the user may occur according to the method shown in FIG. 3. In step 150 the server determines if the user won a lottery. In step 152 the server determines if the winnings are greater than a threshold (e.g. $5000). If the winnings are below the threshold, in step 154 the server may send the winnings directly to the user's payment system. If the winnings are above the threshold, in step 156 the server or the corporation operating the server may send information about the customer to the lottery corporation in order for the lottery corporation to pay the customer directly.

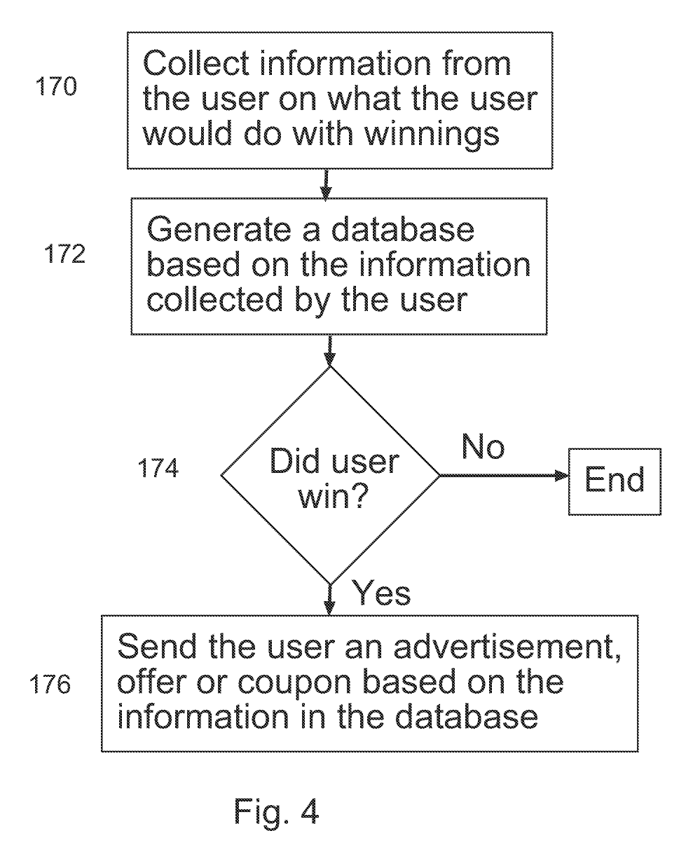

Targeted advertising may be directed to a user of the lottery application according to the method shown in FIG. 4. In step 170 information is collected from the user on what the user would do with the winnings if they won the lottery. The information may be collected, for example, after the user purchases a lottery ticket, or when the user creates their account or at some other time. Based on the user's supplied information, a database is created or updated in step 172 to include information on what the user indicated they would do with the winnings if they won. The database may also include other information, such as information entered when the user created the account or updated at a later date, demographic information, spending history, information collected from the consumer's use of the consumer electronic device (e.g. which consumer electronic device is used to log in, keystrokes on a physical or virtual keyboard, button presses, for example on a remote control, previous channel surfing and television viewing history if the consumer electronic device is a television or used as a television), and the user's history of use of the lottery application, for example amount of money transferred to/from the account, size of wagers, frequency of wagers, choice of specific games, geographic or physical location, choice of numbers/teams, length of play, and time of day the games were played. In step 174, it is determined if the user won a lottery. The database may include user input and information inferred from user input, for example inferred age based on user clicks (for example, the users choice of programs to watch) or other inferred characteristics of the user. If the user won a lottery, the database may be updated (step not shown) with information concerning the amount of winnings and the type of winnings (for example cash winnings, a free play, or some other form of an awarded prize or offer). In response to the user winning a lottery, the user is sent in step 176 an advertisement, offer or coupon based on the information in the database. The advertisement, offer or coupons could include, for example, a gift certificate or a text, graphic or video advertisement. The advertisement, offer or coupon may be sent based on any information in the database including the information on what the user indicated they would do with the winnings and information concerning the amount and type of winnings The information in the database may also be used to provide targeted advertisements which are not in response to a user winning Targeted advertising may be selected locally by the lottery application, for example based at least in part on inputs from the user, or may be selected by the server. The delivery of targeted advertising to the user may be reported to a monitoring system and recorded in a database. There may be multiple users of the lottery system and in an embodiment delivery of targeted advertising may be reported to the monitoring system for some but not all users. Redemption statistics may be collected to determine the success of redemption of offers as the result of the delivery of targeted advertising to the user.

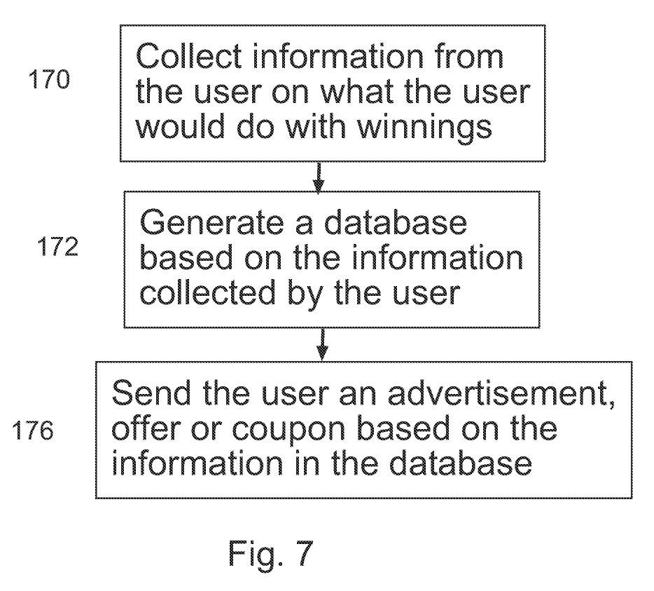

FIG. 7 shows a modified version of the method of FIG. 4 in which the user is sent targeted advertising based on user input at least including information from the user on what the user would do with winnings In step 170 information is collected from the user on what the user would do with the winnings if they won the lottery. Based on the user's supplied information, a database is created or updated in step 172 to include information on what the user indicated they would do with the winnings if they won. The database may also include other information. In step 176 the user is sent an advertisement, offer or coupon based on the information in the database.

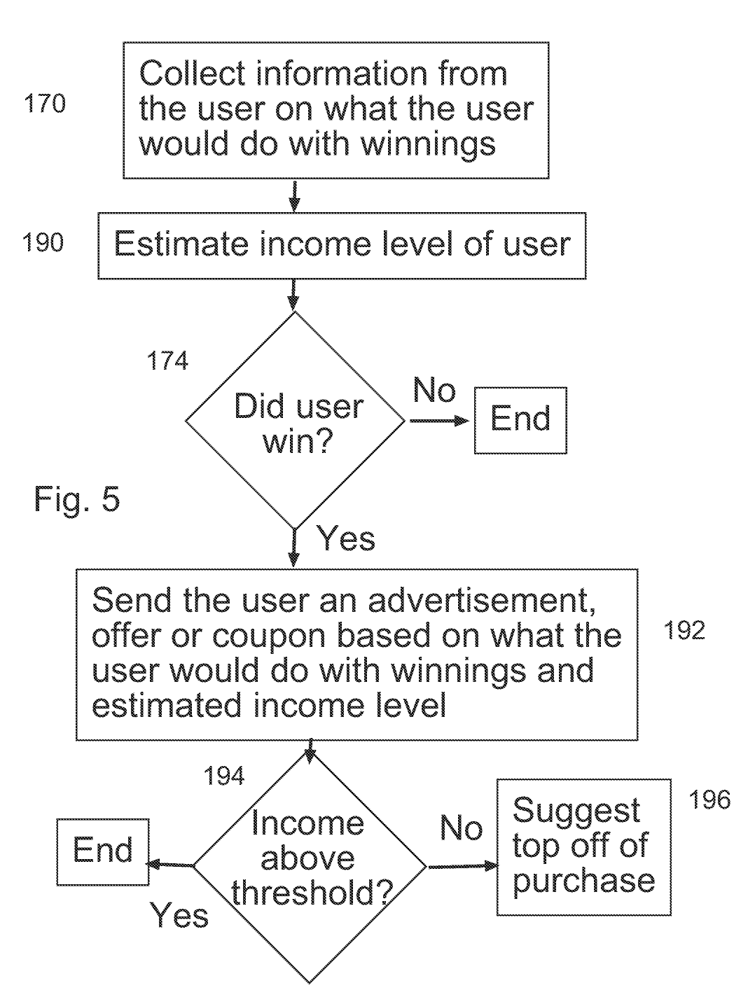

FIG. 5 shows a modified version of the method shown in FIG. 4 in which an estimate of the income level of the user is also used. Income level of the user may be based on, for example, specific input from the user on their income, past purchases by the user, past account funding practice by the user, forms of payments by the user, lottery playing behavior including frequency of play and dollar amounts played, postal addresses, job title, company name, geographic location, programming packages and programs viewed in the case of a television, what they would do with winnings, birthday information provided, or from age verification software. A shown in FIG. 5 in step 170, information is collected from the user on what the user would do with winnings if they won. The information may be collected, for example, in response to the user purchasing a lottery ticket. In step 190, an income level of the user is estimated. In step 174 it is determined if the user won a lottery ticket, for example a lottery ticket in response to the purchase of which the information on what the user would do with the winnings was collected from the user. If the user won, in step 192 the user is sent an advertisement, offer or coupons based on what the user indicated they would do with the winnings and on the estimated income level. Other information about the user may also be used. In step 194, the income level is compared to a threshold, and if the income level is lower than the threshold, in step 196 the user is given a suggestion to top off a purchase with a credit card or other payment method. The purchase may be a purchase promoted by the advertisement, offer or coupon. The threshold may depend on the purchase.

An offer may include an offer provided to the consumer with an option for the consumer to counteroffer a different price (such as by a statement, “I won't pay that but I will pay $X”). If the price suggested by the consumer is above a threshold (not known to the consumer), then a coupon would be provided to the consumer at the price suggested by the consumer, or the consumer may be provided the opportunity to immediately purchase the item at the price suggested by the consumer. The threshold may be a predetermined threshold unknown to the consumer. The threshold may be different for different consumers depending on information about the consumer, for example information about the consumer's income. The threshold may be varied randomly. An offer may also include a coupon provided with two prices, a real price and a fake price. The consumer may be required to make a choice between the prices and given the opportunity to make the purchase only if they select the real price. The real price and the fake price may depend on information about the consumer and may be varied randomly. An offer may include a random chance at receiving one or more offers of a selection of offers. A coupon lottery may be provided in which the user receives a random chance at receiving one or more offers from a selection of offers. The possible outcomes of the coupon lottery may include the user receiving nothing and may include the user receiving free items as in a pure lottery. The user may be provided the opportunity to pay to enter the coupon lottery or it may be provided to the user for free. Merchants may choose to submit offers or coupons through any one or more of these methods, including a fixed price method.

The games available to be played by the user may include lotteries, betting on sports, horse racing, dog racing, raffles, or other games. The word “lottery” in this document should be interpreted to include any of these games. The user may be provided with a reminder of an upcoming event, for example a lottery drawing or sports game, before it occurs. The reminder may be provided while the user is observing other content on the consumer electronics device, for example television programming. The reminder may take the form of, for example, a pop up logo, which may be translucent. The logo may also flash to draw the user's attention. A countdown clock may also be provided. For example: a user could set a timer/reminder to flash a translucent Lotto Max logo 15 minutes before draw time, when jackpots exceed $50 Million, for the month of June. There also, for example, could be a pop up 1 hour before an NFL game where the New York Giants are playing. The reminder may also provide the user with the ability to provide input to rapidly take an action in relation to the event to which the reminder relates. For example, a Lotto Max reminder may be a translucent logo which the user can select to go directly to their account (or if not registered, to the registration page) to purchase a Lotto Max ticket. The reminder may be provided according to preferences set by the user, past ticket purchase info (amount, jackpot sizes, time of purchases, games played), teams chosen in the case of sports, and/or the consumer electronic device used to make past purchases (e.g. TV, Smart Phone, or Computer). A reminder could also be set according to a user response to an advertisement, for example an advertisement for an event may include providing a user with a response opportunity which if used triggers a reminder (for example, a prompt to press a button, and setting up a reminder automatically in response to the pressing of the button). An advertisement may in the same way also provide a user response opportunity to set up a PVR recording for an event. This technology is not limited in use to events associated with lotteries. One manner in which the advertisement may provide the user an opportunity to set up a PVR recording is to embed a code for a program in the advertisement stream. The program code corresponds to a program set to be broadcast at a future time. The advertising data stream is sent from the cable head end. The user's PVR or like device, such as a digital set top box without PVR functionality, is programmed to respond to user input to identify the code in the advertisement stream and automatically set up a future recording of the program in the PVR. The user input may in this instance be the pressing of an otherwise unassigned function key or may be a pressing of a record key followed by selection of two or more options such as record the current program or record the advertised program. The personal video recorder may be any device used for recording broadcast video streams.

Thus there is also provided system and method for viewing a television advertising commercial broadcast over a telecommunications system which allows viewers to schedule a future event to occur related to that commercial advertising broadcast. A unique identifier, or identifiers, and a trigger are added to, or embedded within, the broadcast stream of a particular and specific commercial advertising message or other message. The trigger may cause an image to appear on the viewing screen, potentially in a translucent form, which indicates to the viewer that there are actions available during the airing of this specific commercial message which they can choose to initiate by pressing a button or buttons on their remote control. If no actions are taken then the translucent image, or icon, appears for the life of the airing of the commercial advertising message, or for some other selected period of time, and expire upon the restoration of regular television programming or the expiry of the selected period of time. If the viewer chooses to select, or initiate, the icon by selecting the specific button, or buttons, on the remote control then a choice, or choices, is presented on the viewer's screen dependent upon the commercial advertisement. This functionality may be programmed into the user's PVR or like device according to these instructions.

In the case of a commercial advertisement promoting a specific television show, at a scheduled time, on a scheduled date: Set Auto Tune, Set Reminder, Schedule PVR/DVR recording. By selecting schedule a PVR/DVR recording the customer will further have the ability to schedule a onetime recording or schedule a series recording. The viewer may be prompted to choose a preference for a High Definition or Standard Definition program preference. In the case of selecting a High Definition or Standard Definition selection the software may automatically perform a scan of authorized channels in determining whether the viewer has a subscription to the High Definition program feed, and in this case the software may assign a priority for this recording. The action may be specific to the commercial advertisement being aired and requires a consumer electronic device to be activated with specific software. The consumer electronic device, or telecommunication device, may include a set-top-box, gaming console, over the top TV, cell phone, smart phone, or a computer.

In the case of an Interactive TV application, the message displayed to the viewer and that is embedded in the broadcast stream, may include or may only include a call to access a service, such as an offer to purchase an ecommerce product or service or to launch or view a specific information piece or service. The informational services may include, but are not limited to: weather applications, sports scores & statistics, lottery applications, airport schedule arrival & departure times, location based services which would facilitate searching for restaurants, bars, and commercial stores and businesses of interest which may or may not include names, addresses, phone numbers, Web site addresses, and maps showing the location of retail and business establishments including directions from your current location, which may or may not be linked to a GPS system. The message displayed to the user may provide access to customer service applications which allow Telecommunication customers to access their accounts, sign up or cancel services, view and pay a bill, or to schedule a service call or troubleshooting session. In these examples, the user device is programmed to identify the nature of the message being shown to the user and to react to user input to provide a selected service to the user.

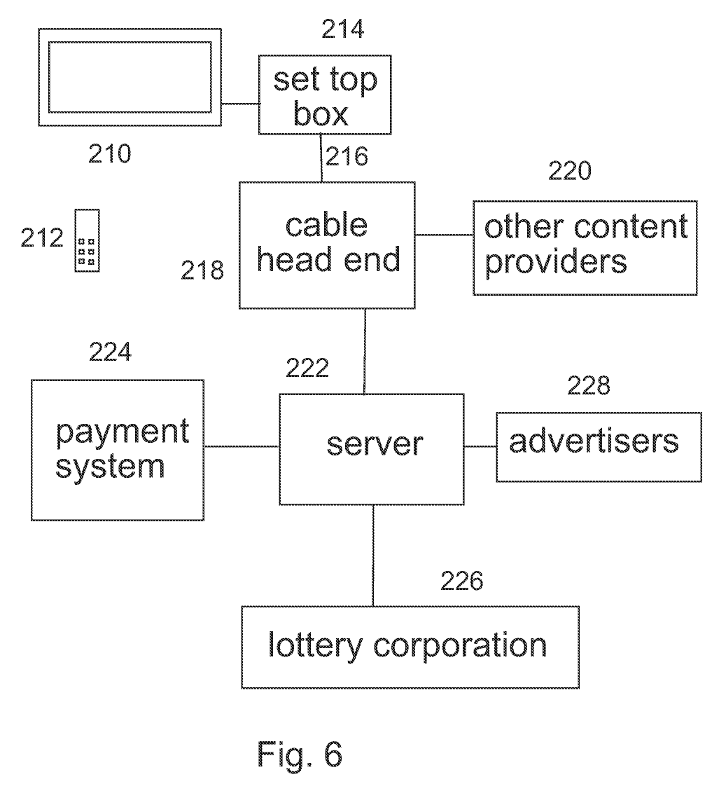

FIG. 6 shows an embodiment of a system for providing lotteries over a cable television network. The user views television 210 and may provide input via remote 212. Television 210 connects to set top box 214 which connects to the cable head end 218 via cable network 216. The cable network may be a conventional cable network distributing content from other content providers 220 as is conventional. The cable head end connects to server 222 and communicates information received from the user via the cable network to server 222 while including information received from server 222 in the stream of information sent to the user via the cable network. The server may connect to cable head end 218 in any suitable manner, for example in any manner that is conventional for an interactive service over cable to connect to a cable head end. The server may be a single server or multiple connected units. If multiple units are used the multiple units may be specialized in particular tasks or may operate in parallel to accomplish similar tasks. The server is connected to one or more payment system 224 in any suitable manner, for example over internet. The payment systems may include, for example, Visa, MasterCard, PayPal, or Debit transfer, etc. The server connects to the payment system to process payments from the user and may connect to the payment system to provide winnings to the user. The server is connected to one or more lottery corporations 226 in any suitable manner, for example over internet. The server sends information to the lottery corporation on, for example, ticket purchases and choices of options when purchasing tickets. The lottery corporation sends to the server information on, for example, winning numbers. In an alternative embodiment, a lottery corporation may license the operation of draws locally at the server and no direct connection to the lottery corporation may be needed. The server may also connect to one or more advertisers 228 in any suitable manner, for example over internet. The advertisers may provide offers to the server for distribution to users. The lines connecting blocks in FIG. 6 are all conventional communication channels of any suitable design.

Advertisers may access a web site of the server to provide offers to be distributed to user of the lottery application. Offers may be received directly from merchants or from intermediaries, who may provide deals on a wholesale basis to target to customers. An ingest engine may sort these offers and target them to the best demographic lottery winning player. The engine would sort based on the best deal, geographic relevance, age, gender, amount, etc. If an offer is received from an intermediary, the engine may rebrand the offer as it is coming from the corporation operating the server. The server would also track, recognize, and notify the intermediary of the commission they are entitled to receive.

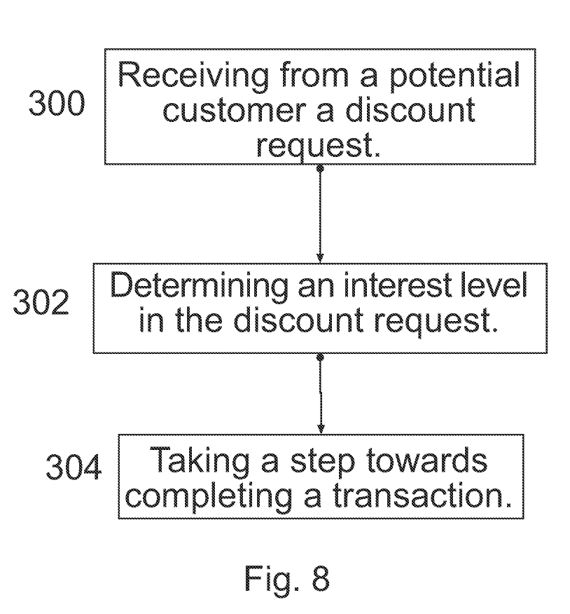

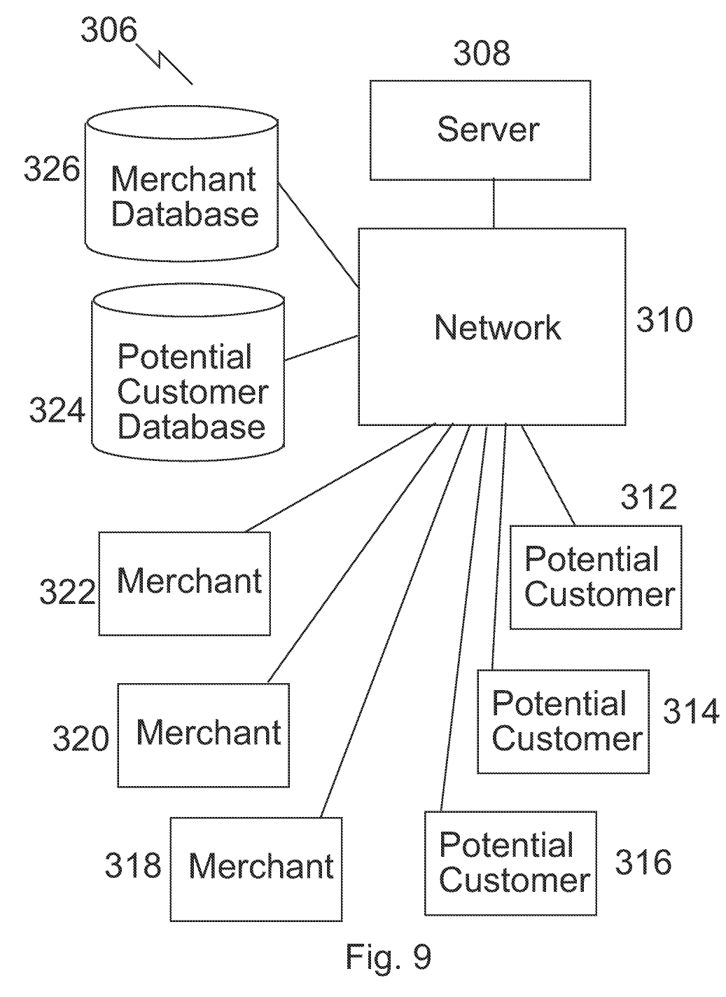

Referring to FIGS. 8 and 9, a method and system 306 of brokering a transaction over one or more telecommunications networks 310 is illustrated. The disclosed embodiments are used to crowd source daily deals in one embodiment. Prior daily deal coupon sites act as a broker by offering daily deals within specific cities at the request of participating storeowners (business owner origination). As a result the offer sent to potential customers, usually registered recipients, is not targeted or filtered for the customer's unique sets of interests. A disadvantage of business owner origination is that recipients who are hopeful of a pending offer for a specific store of interest to them and which they may have familiarity with, or even frequent on a regular basis, are required to wait and watch for the desired discount offer.

The method of FIG. 8 illustrates a system and method of leveraging the interest of interested individuals combined with the power of crowd sourcing to approach specific stores (merchants 318, 320, 322) with a “reversed” Daily Deal in one embodiment. The disclosed system and method have the advantage of allowing potential customers 312, 314, 316 to take an active role in deal generation instead of the traditionally passive role of waiting and watching for a deal to come out. As shown, a server 308 is configured to connect to a plurality of potential customers 312, 314, 316 over the telecommunications network 310. In stage 300, a discount request for a merchant 318, 320, or 322 is received from a potential customer 312. The discount request may be simply a generic request for a suitable discount from merchant 318, or the request may be more specific, for example the request may propose one or more criteria for a discount, such as an identification of a ware or service and a proposed discounted price. For further example, the discount request may include a discount request for a $40 manicure offered at a neighborhood spa (merchant 318). An account holder (potential customer 312) of the discount broker 308 may originate a discount by setting up a proposed deal for consideration, say a $30 price for the manicure. The potential customer 312 may enter merchant identifying information such as the store name, address, postal code, phone number, and email address, ware or service identifying information, and other relevant information such as the retail price of the offer and the proposed discounted price.

In stage 302, on submission of the discount request the broker (server 308) determines an interest level in the discount request among other potential customers 314, 316. Determining an interest level may further comprise sending the discount request to other potential customers 314, 316, and receiving feedback on the discount request from the other potential customers 314, 316. For example, the broker may scour a potential customer database 324 to find other interested account holders, or may broadcast a potential offer to a pre-determined group of relevant recipients in that geographic territory, potentially with the same interests determined on an objective basis such as preferences stored in potential customer database 324. Interest may be inferred based on preferences stored in potential customer database 324. Interested potential customers may have a chance to modify or counter the discount request, and the discount request may be modified according to the feedback received. For example, an average requested price may be incorporated into the discount request to be sent to the merchant 318 in stage 304. In one example potential customers must take an action such as making a deposit or payment to the broker to demonstrate interest.

In a stage 304, if the interest level is above a threshold, at least a step towards completing a transaction corresponding to the discount request is taken with at least one of the potential customers 312, 324 or 316. Thus, for example once a critical mass of interested potential customers is achieved on the basis of account holders signing up in support of the proposed discount, the broker may negotiate a discount with the merchant 318. The step, of the at least a step taken towards completion, may comprise sending the discount request to the merchant 318 and in response to a subsequent action by the merchant 318, offering a discount to the one or more potential customers 312, 314, and 316. The subsequent action may comprise accepting or countering the discount request, and the discount may thus correspond to the accepted or countered discount request. If the discount request is accepted by the merchant 318, the broker may take the step by processing the discount automatically to provide the discount to interested parties for example directly by forwarding the discount to potential customers 312, 314, 316 or indirectly by making the discount available to the potential customers 312, 314, 316 by posting on the broker's website. If a counteroffer is made by merchant 318 then the broker may take the step by presenting the offer to interested parties. In essence the method may be a digital discount bartering system with a bulk purchasing dynamic. Negotiations between broker and merchant may include negotiations of the remediation to be received by the broker, for example the cut to be received by the broker with regards to every discount that results in a completed transaction.

The system may screen out discount requests that have one or more criteria outside a predetermined criteria range. The predetermined criteria range may be based on information provided in advance by the merchant 318, or information based on reasonable criteria determined by other means such as by the broker's own knowledge. For example the predetermined criteria may comprise price, and a proposed price that is too low would result in the discount request being rejected. In other words, the system may apply business logic to the discount request or the criteria used to establish the definition of an “interested” customer and the pool of potential customers to use in determining the interest level. The business logic may ensure that a potential bona-fide deal has some degree of reasonability prior to presentation to a merchant or issuance of a discount. Other criteria include geographic distance from the merchant of the requesting customer or the pool of potential customers to obtain feedback from. The range of acceptable geographic distance may change based upon the product or service. For example: a manicure may have a relevant geographic radius of 25 km, whereas a bed and breakfast may have a geographic radius of 400 km. Another criteria to look at in determining the appropriate interest level required to act on the discount request is the nature of the ware or service. For example, a manicure may need 20 potential customers to be interested before a deal makes sense, a deal on a bike shop may only require 5 potential customers, and a lottery deal may require 1000 potential customers. In some cases, when a discount request is screened out, the broker may inform the originator that the discount request was screened out. Informing the originator may include informing the originator of what criteria of the discount request was outside of the predetermined criteria, so that the originator can make changes and regenerate a revised request if desired.

In some cases, the broker may be pre-authorized by a merchant to offer discounts to potential customers on a determination by the broker that the suitable interest level exists. A broker pre-authorized by a merchant may apply predetermined logic agreed upon by the merchant to determine if the required conditions are met before a discount is issued.

Before sending the discount request to the merchant 318, for example through network 310, the broker may search for an existing discount offered by the merchant 318. Such a stage may or may not be carried out only if a minimum or maximum threshold of interested potential customers exists. If the existing discount is found, the existing discount may be offered to the one or more potential customers 312, 314, 316 instead of issuing a new discount. Thus, once an originator of a deal has put forward an offer and the broker has broadcast a deal request to its database of potential interested customers, resulting in interest, the broker may search information from other daily deal providers for a deal already existing for the merchant in question and which the originator and its supporters are unaware of at the time. If such a coupon already exists for that particular merchant 318 the broker may negotiate a deal with the other daily deal company to provide the existing coupon to the broker's customers who have agreed to purchase.

The discount or deal may be an offer for a discounted price, a rebate, a free ware or service, a combined offer, or another suitable offer. The broker may allow the merchant 318 to take the at least a step towards completing the transaction with the potential customer, for example by providing the merchant 318 with information required to directly contact the pool of potential customers or allowing the merchant to indirectly contact the potential customers for example by posting the discount on the merchant's website. Taking at least a step towards completion of the transaction may include taking all steps required to complete the transaction, for example if the broker acts as a middleman by accepting payment for the discount directly from the potential customer(s). In one embodiment if the discount request is accepted, the broker automatically completes the transaction with the potential customer who originated the discount request. Thus, it may be a requirement that if the proposed or countered discount request is accepted an originator is already committed if the final discount is the same as the discount request or is within a predetermined range of suitable discounts pre-authorized for acceptance by the originator. In addition, all potential customers that demonstrated interest in the discount request may be required to commit to the final discount as well.

Server 308 may be a computer configured to connect to potential customers and merchants through a telecommunications network 310 such as the internet. Server 308 may include a computer readable storage medium storing software for carrying out the method, and a suitable processing system for operating the software. Server 308 may be a remotely accessible server made available by cloud computing, in which shared resources are used to deliver the service. Software used to carry out the method may be located entirely on server or servers 308, or may be located partially on computers operated by potential customers and merchants. The software that carries out the deals may be accessible by the merchants and potential customers, and may be browser enabled so could reside in one or more servers or in the cloud. The databases 326 and 324 are electronic databases that may reside in the one or more servers 308 or may be at one or more other locations accessible through cloud computing. Software required to carry out the method may be distributed to one or both merchants and potential customers, for example if each merchant and potential customer downloads software required to communicate with server 308. In some such embodiments, respective databases saved by each merchant or potential customer may perform periodic or continual updates with server 308 to ensure that databases 324 and 326 are up to date, for example as new customers and merchants come and go from the system or as existing customers and merchants modify preferences. In the case of pre-authorization by a merchant for discount generation by server 308, a merchant may be provided access to server 308 to update preferences related to the objective basis used by server 308 to determine whether a discount should be generated for the merchant. In some cases, the method may be carried out with respect to a merchant or potential customer that has not previously been part of the system and does not have respective information stored on one of databases 324, 326. For example, a potential customer who is or is not an existing registered user of the system may approach server 308 with a discount request for a merchant who is or is not registered with server 308 to use the system. Thus, the system may be flexible and adaptable as new businesses and customer demands arise. In some cases interest level may be determined by resort to potential customers that aren't in the database 324, for example if cold calls are made to new potential customers located within a geographic area. The databases 324 and 326 may be generated through one or both of use of system 306 or another system such as a lottery system. Thus, information on merchants and potential customers may be shared between systems to achieve effective coverage.

Lines connecting elements in the systems of FIGS. 6 and 9 are conventional communication links of any type for example wired, wireless or optical. Communications may be carried out entirely or partially through the internet, or communications may be carried out via other suitable telecommunications connections such as by fax, phone, or mail to give some examples. In one embodiment only electronic telecommunications are used. Potential customers and merchants may communicate with network 310 through a suitable terminal device such as a Set Top Box (for example Cable, IPTV, or Satellite), a gaming console (for example XBOX, PlayStation, or WII), Over The Top TV, a cell phone, a smart phone, or a computer.

Multiple offers or coupons may be displayed to the user simultaneously in a grid format. Offers or coupons may be categorized based on, for example, the type of business and geographic area and displayed to the user grouped according to category. Offers or coupons may be categorized based on geographic area relative to the location of the user, for example according to distance from the user. The offers or coupons in a category may be displayed in a group in a grid format.

All offers and communications described herein are made by sending of electronic messages over an electronic communications network, such as an internet protocol based network, a cable network, a telephone network or a combination of such networks.

Completing a transaction means sending an affirmation message via a telecommunications network in response to an offer made over a telecommunications network and generating a saved record in a persistent computer memory that records details of the saved transaction. In addition, a payment may be taken, for example via an eWallet, credit card, debit transfer, wire transfer, or other suitable payment mode. The saved record contains sufficient information to identify directly or indirectly the parties to the transaction, what has been transacted and the date of the transaction. The persistent computer memory may be associated with a specific server or may be a shared resource. The persistent computer memory could reside at any of the elements shown in FIG. 9 including anywhere suitable within the network itself. The saved record in the persistent computer memory is a physical record comprising a mechanical, electrical, magnetic, electro-magnetic, optical or quantum mechanical element in a specific state. Each reference to sending or receiving is a reference to a message sent over conventional telecommunication channels, including electrical, electromagnetic and optical channels. For example, a message may be sent or received via email, the Web, phone, text, or another suitable method.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A method of targeted advertising in an electronic lottery system, comprising:
the electronic lottery system collecting input from a user about what the user would do with winnings if they won a lottery;
generating an electronic database based on the user input; and
sending the user an advertisement, offer or coupon based upon the information in the electronic database.

2. The method of claim 1 further comprising monitoring whether the player wins a lottery using the electronic lottery system and sending the player the advertisement, offer or coupon in response to the user winning

3. The method of claim 2 further comprising estimating an income level of the user and sending the player the advertisement, offer or coupon based on the income level.

4. The method of claim 3 further comprising comparing the estimated income level of the user to a threshold and in the event that the estimated income level is below the threshold suggesting to the user that the user top off a purchase with a credit card.

5. A system for providing a lottery over a telecommunication system to a user using a consumer electronics device, the system comprising a server configured to connect to the consumer electronics device over the telecommunication system, the server also configured to connect to a payment system to process payments from the user.

6. The system for providing a lottery over a telecommunications system of claim 5 in which the telecommunications system is a cable network.

7. The system for providing a lottery over a telecommunications system of claim 5 in which the server is also configured to provide an offer, advertisement or coupon to the user.

8. The system of claim 5 in which the server is configured to provide the offer, advertisement or coupon contingent upon the user winning a prize in a lottery.

9. The system of claim 8 in which the server includes a database of user supplied information on what the user would do with winnings and the server is configured to provide the offer, advertisement or coupon based on the user supplied information.

10. The system of claim 9 in which the server is configured to supply the user with top up payment options.

11.-13. (canceled)

14. A method of delivering content to a user over a communications device, comprising receiving at the communications device a code embedded in an advertising stream, the code corresponding to a service and in response to user input while the advertising stream is being received, the communications device providing the user with access to the service.

15. The method of claim 14 in which the user is notified of the availability of the service by a pop up window on the communications device.

16. The method of claim 14 in which the communications device is a PVR.

17. The method of claim 14 in which the code is a program code that corresponds to program set to be broadcast in the future and the service is setting up a recording of the program.

18. The method of claim 14 in which the code relates to an account of the user and the service is providing access to the account.

19. The method of claim 14 in which the code relates to a service offered over interactive television and the service is providing access to the service.

20. A method of brokering a transaction over a telecommunications network, the method comprising:
receiving from a potential customer a discount request for a merchant;
determining an interest level in the discount request among other potential customers;
if the interest level is above a threshold, taking at least a step towards completing a transaction corresponding to the discount request with at least one of the potential customers.

21. The method of claim 20 in which taking at least a step towards completing a transaction further comprises:
sending the discount request to the merchant; and
in response to a subsequent action by the merchant, offering a discount to the one or more potential customers.

22. The method of claim 21 in which the subsequent action comprises accepting or countering the discount request, and the discount corresponds to the accepted or countered discount request.

23. The method of claim 20 in which determining an interest level further comprises:
sending the discount request to the other potential customers; and
receiving feedback on the discount request from the other potential customers.

24. The method of claim 20 in which the discount request is for a lottery service of the merchant.

25. The method of claim 20 further comprising screening out the discount request if one or more criteria of the discount request is outside a predetermined criteria range.

26. The method of claim 25 in which the predetermined criteria comprises price.

27. The method of claim 20 further comprising:
before sending the discount request to the merchant, searching for an existing discount offered by the merchant; and
if the existing discount is found, offering the existing discount to the one or more potential customers.
